(19) United States
(12) Patent Application Publication
(10) Pub. No.: US 2025/0231400 A1
(43) Pub. Date: Jul. 17, 2025

(54) OPTICAL ELEMENT, OPTICAL EQUIPMENT, IMAGE PICKUP APPARATUS, AND METHOD OF MANUFACTURING OPTICAL ELEMENT

(71) Applicant: CANON KABUSHIKI KAISHA, Tokyo (JP)

(72) Inventor: MAMO MATSUMOTO, Kanagawa (JP)

(21) Appl. No.: 19/022,800

(22) Filed: Jan. 15, 2025

(30) Foreign Application Priority Data
Jan. 17, 2024 (JP) 2024-005012

(51) Int. Cl. G02B 27/00

(52) U.S. Cl. CPC G02B 27/0025

(57) ABSTRACT

An optical element includes a glass base material including a first surface and a second surface opposed to the first surface, a resin portion provided on the first surface, and a light-shielding film configured to cover at least a part of a side surface of the glass base material and a part of the first surface. The second surface is an incident surface or an exit surface for light. A part of the light-shielding film is provided between the glass base material and the resin portion. A linear expansion coefficient of the light-shielding film is between a linear expansion coefficient of the glass base material and a linear expansion coefficient of the resin portion.

### BACKGROUND

### Technical Field

The present disclosure relates to an optical element, optical equipment, an image pickup apparatus, and a method of manufacturing an optical element.

### Description of the Related Art

As one of optical elements, a lens having a transparent base material such as glass on which a cured product of a resin composition is provided has been known. This type of lens is manufactured with use of a mold by providing a resin composition between the base material and the mold, and forming a cured product of a desired shape on a surface of the base material through polymerization or copolymerization. A lens manufactured by such a manufacturing method is called “replica element.”

There has hitherto been known a method of reducing internal reflection due to unrequired light by forming a light-shielding film on an edge portion of the lens for the purpose of improving quality of appearance of the replica element.

In Japanese Patent Application Laid-Open No. H07-072309, there is disclosed, as an example of the replica element, an aspherical lens molded so that an edge surface of an outermost circumference of the cured product of the resin composition is covered with a light-shielding film.

However, although an optical element as disclosed in Japanese Patent Application Laid-Open No. H07-072309 has excellent quality of appearance, cracking of a resin is caused in some cases when the optical element is used in a low temperature environment, resulting in a disadvantage in environmental durability of a lens.

### SUMMARY

An aspect of the present invention is to provide an optical element that has both excellent quality of appearance and excellent environmental durability, and a method of manufacturing the optical element.

According to one aspect of the present disclosure, there is provided an optical element including: a glass base material including a first surface and a second surface opposed to the first surface; a resin portion provided on the first surface; and a light-shielding film configured to cover at least a part of a side surface of the glass base material and a part of the first surface. The second surface is one of an incident surface or an exit surface for light. A part of the light-shielding film is provided between the glass base material and the resin portion. A linear expansion coefficient of the light-shielding film is between a linear expansion coefficient of the glass base material and a linear expansion coefficient of the resin portion.

According to another aspect of the present disclosure, there is provided a method of manufacturing an optical element, the optical element including a glass base material and a resin portion, the glass base material including a first surface and a second surface opposed to the first surface, the resin portion being provided on the first surface, the second surface being one of an incident surface or an exit surface for light, the method including: a preparation step of preparing the glass base material on which a light-shielding film has been formed; a filling step of filling a space between the glass base material and a mold with a resin composition; a curing step of curing the resin composition to form the resin portion; and a mold release step of releasing the resin portion from the mold. The light-shielding film is formed on the glass base material so as to cover at least a part of a side surface of the glass base material and a part of the first surface. The filling step includes filling with the resin composition so that a space between the light-shielding film and the mold is filled with part of the resin composition.

Further features of the present disclosure will become apparent from the following description of exemplary embodiments with reference to the attached drawings.

### BRIEF DESCRIPTION OF THE DRAWINGS

FIG. 1A, FIG. 1B, and FIG. 1C are schematic views for illustrating an optical element according to a first embodiment of the present disclosure.

FIG. 2 is a schematic view for illustrating an optical element according to another embodiment of the present disclosure.

FIG. 3 is a schematic view for illustrating an optical element according to still another embodiment of the present disclosure.

FIG. 4A and FIG. 4B are schematic views for illustrating a method of manufacturing the optical element according to the first embodiment of the present disclosure.

FIG. 5 is a schematic view for illustrating an image pickup apparatus according to a second embodiment of the present disclosure.

### DESCRIPTION OF THE EMBODIMENTS

### First Embodiment

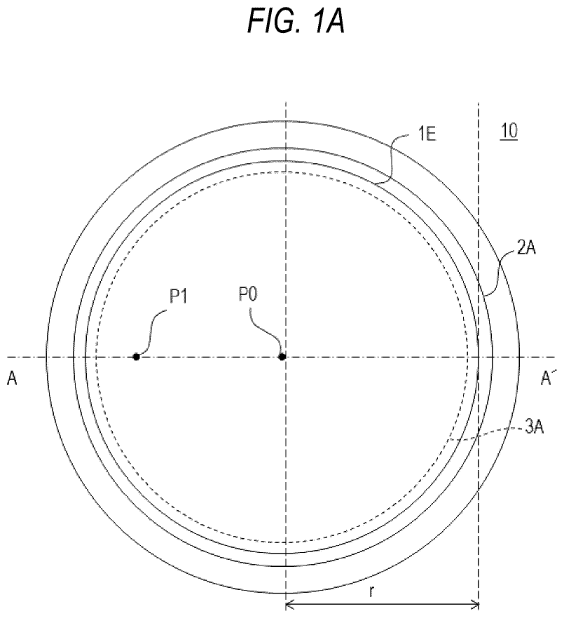

Description is given on an optical element according to a first embodiment of the present disclosure and a method of manufacturing the optical element, with reference to FIG. 1A to FIG. 1C.

First, a configuration of the optical element according to this embodiment is described with reference to FIG. 1A to FIG. 1C. FIG. 1A to FIG. 1C are schematic views for illustrating a configuration of an optical element 10 according to this embodiment.

FIG. 1A is a plan view for illustrating the optical element 10. FIG. 1B is a sectional view in a thickness direction taken along the line A-A′ in FIG. 1A. FIG. 1C is a sectional view for illustrating a part of the optical element 10 in an enlarged manner.

The optical element 10 according to this embodiment is an optical element of a type called “replica lens.” As illustrated in FIG. 1A to FIG. 1C, the optical element 10 according to this embodiment includes a glass base material 1 which is transparent and a resin portion 2 which is a cured product of a resin composition formed on the glass base material 1. The resin portion 2 is provided so as to be in close contact with a first surface 1A of the glass base material 1. A thickness of the resin portion 2 in an optical axis direction O is not uniform in a radial direction of the optical element 10, and has a non-uniform in-plane distribution. This gives a surface of the resin portion 2 an aspherical shape.

The optical element 10 according to this embodiment is configured as an aspherical lens by including the resin portion 2, and can accordingly be manufactured in short cycles compared to an aspherical lens configured from glass alone. Consequently, according to this embodiment, an aspherical lens can be manufactured at a low cost.

The optical element 10 also includes a light-shielding film 3 covering at least a part of a side surface 1F of the glass base material 1 and a part of an outermost circumference of the first surface 1A. The light-shielding film 3 is formed so as to be in close contact with the glass base material 1.

The glass base material 1 includes the first surface 1A and a second surface 1B. The first surface 1A includes: an optical surface 1C which is a spherical surface; and a flat surface 1D. The second surface 1B is opposed to the first surface 1A. The optical surface 1C has a concave spherical shape, and the second surface 1B has a convex spherical shape. The flat surface 1D is provided so as to connect to the optical surface 1C by surrounding the optical surface 1C via a ridge line 1E. That is, the first surface 1A includes the optical surface 1C, the flat surface 1D provided at an outer rim of the optical surface 1C, and the ridge line 1E, which is a boundary line between the optical surface 1C and the flat surface 1D. The second surface 1B is one of an incident surface and an exit surface for light in the optical element 10. Of two optical surfaces included in the resin portion 2, the surface on a side opposite from the surface that is in contact with the first surface 1A is another one of the incident surface and the exit surface for light in the optical element 10. The first surface 1A and the surface at which the resin portion 2 is in contact with the first surface 1A are each a refracting surface for light in the optical element 10. That is, the surface in the optical element 10 that includes the resin portion 2 is in a state open to outside air, and no other optical elements are provided on the surface that includes the resin portion 2.

The resin portion 2 is preferred to be provided so as to spread from the optical surface 1C, cross the ridge line 1E, and reach a part of the flat surface 1D as illustrated in FIG. 1A to FIG. 1C. In this case, a distal end 2A of the resin portion 2 sits on the flat surface 1D.

A part of the light-shielding film 3 is provided between the resin portion 2 and the glass base material 1 in an outermost circumference of the resin portion 2. With this configuration, the light-shielding film 3 can block a bright line caused by irregular reflection due to internal reflection of unrequired light taken in from a side surface of the outermost circumference of the resin portion 2 when viewed from the second surface 1B side of the glass base material 1. Accordingly, quality of appearance can be improved. In the present disclosure, a linear expansion coefficient of the light-shielding film 3 is between a linear expansion coefficient of the glass base material 1 and a linear expansion coefficient of the resin portion 2. This enables the light-shielding film 3 to, in the event of a thermal shock such as rapid cooling of the optical element 10, mitigate thermal stress caused by a difference in linear expansion coefficient between the resin portion 2 and the glass base material 1, with the result that the optical element 10 maintaining high environmental durability for a long time can be obtained.

In the optical element 10 illustrated in FIG. 1A to FIG. 1C, a thickness of the resin portion 2 having an aspherical shape at a center P0, which is a center of the spherical optical surface 1C, is exceeded by a thickness of the resin portion 2 at a point P1, which is located between the center P0 and an end portion, and the thickness at the point P1 is a maximum thickness of the resin portion 2. Here, a thickness of the resin portion 2 refers to a thickness in the optical axis direction O in relation to the optical surface 1C, which is a spherical surface of the glass base material 1. In the present disclosure, a thickness of the resin portion 2 at a point Px, which is a certain point in a radial direction of the optical surface 1C, is regarded as an average value of thicknesses obtained by measuring at three points in total of the point Px, a point Px−1, and a point Px+1. The point Px−1 and the point Px+1 are two points adjacent to the point Px that are each distanced from the point Px by 0.5 mm in the radial direction of the optical surface 1C. The point Px−1 is a point positioned closer to the center P0 than the point Px is, and the point Px+1 is a point closer to the outer circumference of the optical surface 1C than the point Px is. With the resin portion 2 molded so as to have such a shape, the optical element 10 which is a replica lens is configured as an aspherical lens having an aspherical shape.

The optical element 10 is preferred to satisfy at least one of the following two conditions. One of the conditions is that a ratio of the maximum thickness of the resin portion 2 in the optical axis direction O to the thickness of the resin portion 2 in the optical axis direction O at the center position P0 of the optical surface 1C is 5 or more. The optical element 10 that has a value of 5 or more as the ratio of the thickness of the resin portion 2 at the point P1 to the thickness of the resin portion 2 at the center position of the optical surface 1C is large in aspherical surface quantity, and accordingly has optical characteristics suitable for use as a front element of a wide zoom lens.

Another one of the conditions is that a ratio of a minimum thickness of the resin portion 2 in the optical axis direction O to the thickness of the resin portion 2 in the optical axis direction O at the center position of the optical surface 1C is ⅕ or less. The optical element 10 that satisfies the another condition is also large in aspherical surface quantity, and is accordingly more effective in terms of correction of distortion and chromatic aberration. Consequently, the use of the optical element 10 that satisfies the another condition yields excellent image quality in a wide lens required to have a particularly wide viewing field, a telephoto lens, and the like.

On the other hand, in a replica lens large in aspherical surface quantity, the resin portion 2 is susceptible to cracks due to stress from a thermal shock under influence of an increased residual stress in molding. This is because, when the resin portion 2 is excessively thick, thermal stress increases in proportion to the thickness of the resin portion 2, and as a result, probability of the resin portion cracking rises. Concentration of stress from a thermal shock tends to occur particularly in a part of the resin portion 2 that is formed on the ridge line 1E, and it is accordingly preferred to interpose the light-shielding film 3 as a stress mitigating layer on the ridge line 1E. That is, the light-shielding film 3 is preferred to be provided so as to spread from the flat surface 1D, cross the ridge line 1E, and reach a part of the optical surface 1C as illustrated in FIG. 1A to FIG. 1C. This enables the light-shielding film 3 to effectively block the bright line as well. In this case, a distal end 3A of the light-shielding film 3 provided on the first surface 1A sits on the optical surface 1C.

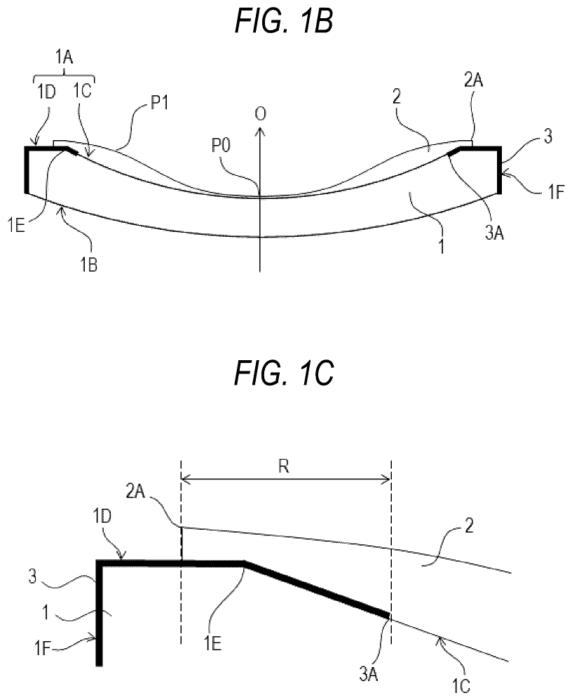

However, configurations of the resin portion 2 and the light-shielding film 3 in the present disclosure are not limited to the example illustrated in FIG. 1A to FIG. 1C. For example, as illustrated in FIG. 2, the light-shielding film 3 may be provided only on at least a part of the flat surface 1D, without crossing the ridge line 1E. Also in this case, cracking of the resin portion 2 can be reduced by interposing the light-shielding film 3 that has an appropriate linear expansion coefficient between the glass base material 1 and the resin portion 2 at an end portion of the resin portion 2.

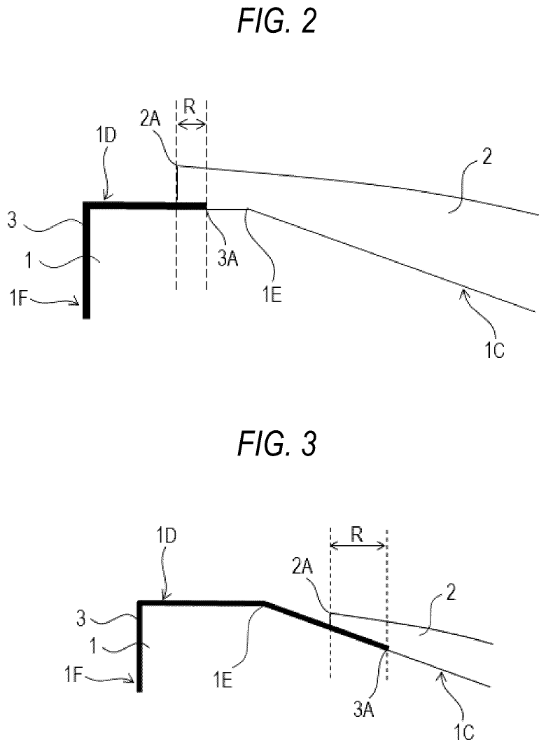

To give another example, as illustrated in FIG. 3, the resin portion 2 may have the outermost circumference on the optical surface 1C without crossing the ridge line 1E so that no resin portion 2 is provided on the flat surface 1D. In this case, the light-shielding film 3 is formed continuously from the flat surface 1D to the optical surface 1C by crossing the ridge line 1E, and as in the example illustrated in FIG. 2, it is important to interpose the light-shielding film 3 that has an appropriate linear expansion coefficient between the glass base material 1 and the resin portion 2 at the outermost circumference of the resin portion 2.

In short, in the present disclosure, the outermost circumference of the resin portion 2 can be located on whichever of the optical surface 1C and the flat surface 1D, and an indispensable configuration is to interpose the light-shielding film 3 that has an appropriate linear expansion coefficient between the glass base material 1 and the resin portion 2 at the outermost circumference of the resin portion 2. This enables improvement in the quality of appearance of the optical element 10 and further enables reduction of cracking of the resin portion 2 by mitigating thermal stress.

In the optical element 10 according to this embodiment, a width of a lamination region R, which is a region in which the resin portion 2 and the light-shielding film 3 are stacked, in a direction perpendicular to the optical axis direction O is preferred to be 1% or more and 10% or less when a radius “r” of the optical surface 1C is 100%. The radius “r” of the optical surface 1C is a distance from the center P0 of the optical surface 1C to the ridge line 1E in the direction perpendicular to the optical axis direction O. In a case in which a proportion of the width of the lamination region R to the radius “r” of the optical surface 1C is 1% or more, the bright line can be reduced even when a half-open angle of the optical element 10 is large, and a drop in the quality of appearance can accordingly be reduced. In addition, the large width of the lamination region R enables the light-shielding film 3 to effectively function as the stress mitigating layer. When the proportion of the width of the lamination region R to the radius “r” of the optical surface 1C is 10% or less, an unrequired increase in outer diameter of the lens can be avoided.

In the present disclosure, there is no particular limitation on the linear expansion coefficient of the resin portion 2. However, when the linear expansion coefficient of the resin portion 2 is 50 ppm/K or more, which is a value distant from the linear expansion coefficient of the glass base material 1, although thermal stress is large, the resin portion 2 is resistant to cracking owing to high ductility of the resin portion 2. When the linear expansion coefficient of the resin portion 2 is 150 ppm/K or less, a difference from the linear expansion coefficient of the glass base material 1 is not excessively large, and the chance of thermal stress becoming excessively large can accordingly be reduced. Accordingly, the linear expansion coefficient of the resin portion 2 is preferred to be 50 ppm/K or more and 150 ppm/K or less. The linear expansion coefficient here is a value measured in a normal temperature range of from −30° C. to 70° C. with use of thermomechanical analysis (TMA) or the like.

Unlike a cemented lens and other similar lenses, in the replica lens, a surface of the resin portion 2 on the side opposite from the side that is in contact with the glass base material 1 is exposed to the atmospheric air. Accordingly, the resin portion 2 absorbs moisture in the air to expand. Due to the expansion of the resin portion 2, residual stress is generated in the replica lens, and hence may cause the resin portion 2 to crack in the event of a rapid thermal shock. The resin portion 2 of the optical element 1 according to this embodiment is accordingly preferred to have a moisture absorption expansion rate of 0.8% or less. This reduces expansion of the resin portion 2 from absorption of moisture, to thereby be able to reduce cracking of the resin portion 2 even more. The moisture absorption expansion rate of the resin portion 2 is more preferred to be 0.5% or less,

As described above, the optical element 10 can have excellent quality of appearance and excellent environmental durability both at the same time by interposing the light-shielding film 3 that has an appropriate linear expansion coefficient between the resin portion 2 and the glass base material 1 at the outermost peripheral portion of the resin portion 2.

As the glass base material 1, a base material made of transparent glass is usable. The term “transparent” as used herein means to have a transmittance of 10% or more with respect to light in a wavelength range of 400 nm or more and 780 nm or less. To give a specific example, a base material made of general optical glass, which is represented by silicate glass, borosilicate glass, and phosphate glass, or made of quartz glass, glass-ceramics, or the like is usable as the glass base material 1.

Although a case in which the optical surface 1C has a concave spherical shape and the second surface 1B has a convex spherical shape is illustrated in FIG. 1A to FIG. 1C, the glass base material 1 is not limited to a particular shape. The optical surface 1C included in the first surface 1A, which is a surface of the glass base material 1 that is in contact with the resin portion 2, can have a suitable shape selected from a concave spherical shape, a convex spherical shape, an axially symmetric aspherical shape, a flat shape, and others as a shape that suits desired characteristics.

As illustrated in FIG. 1A, the glass base material 1 is preferred to have a circular planar shape when viewed in plan view in a direction along an optical axis of the optical element 10 passing through the center P0 of the optical surface 1C which is a lens center. With the glass base material 1 having a circular planar shape, the precision in assembling the optical element 10 is installed in the case of using the optical element 10 as a lens in an optical system as described later can be improved.

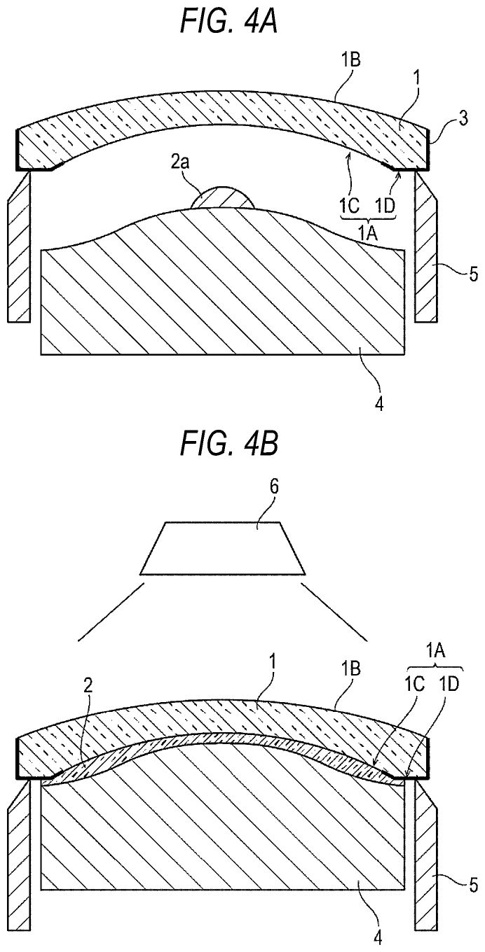

In this embodiment, the resin portion 2 is provided on the optical surface 1C of the glass base material 1 and on a part of the flat surface 1D reached by crossing the ridge line 1E, so as to be in close contact with the glass base material 1 or the light-shielding film 3. A surface of the resin portion 2 has an aspherical shape. The resin portion 2 has a linear expansion coefficient different from the linear expansion coefficient of the glass base material 1. A resin composition 2a (see FIG. 4A) for forming the resin portion 2 is preferred to be a polymer composition that is an energy-curable composition suitable for molding with use of a mold. An energy-curable composition is a composition containing a component that becomes a resin from an uncured state through polymerization and curing caused by imparting one or both of optical energy and thermal energy. Among energy-curable compositions, a UV-curable resin composition is more preferred as the resin composition 2a. As a UV-curable material to be contained in the UV-curable resin composition, a monomer containing a (meth)acrylate group and an epoxy resin containing a (meth)acrylate group, for example, are usable. The term “(meth)acrylate” as used herein means an acrylate or a methacrylate. That is, for example, the “(meth)acrylate group” means an acrylate group or a methacrylate group.

The resin portion 2 which is a cured product of the resin composition 2a is made of an organic material, and thus differs in linear expansion coefficient from the glass base material 1 with which the resin portion 2 is combined. Accordingly, when there is a temperature change in the optical element 10 configured as described above, thermal stress is generated mainly in a part of the resin portion 2 that is located along the ridge line 1E. However, according to this embodiment, the thermal stress is dispersed as described above, with the result that cracking of the resin portion 2 due to the thermal stress is reduced or prevented.

The resin composition 2a for forming the resin portion 2 contains a curable material, and a polymerizable monomer may be used as the curable material. Examples of the polymerizable monomer may include: (meth)acrylate monomers, such as methyl methacrylate, ethylene methacrylate, methyl acrylate, ethyl acrylate, and butyl acrylate; and ethylene-based unsaturated monomers, such as acrylic acid, styrene, butadiene, and divinylbenzene. For the purpose of making the resin composition 2a easy to handle, adjustment such as increasing viscosity of the resin composition 2a may be performed by using, as the curable material, a polymerizable monomer that has been increased in molecular weight in advance. In order to adjust an optical property and a mechanical property, the resin composition 2a may contain an organic substance and an inorganic substance other than the curable material.

The resin composition 2a may also contain a polymerization initiator. The polymerization initiator may be a photopolymerization initiator or a thermal polymerization initiator, and which one of the two is to be used can be determined by what manufacturing process is selected. However, in a case of executing replica molding for forming the aspherical shape of the resin portion 2, the polymerization initiator is preferred to be a photopolymerization initiator in view of its high curing speed.

Examples of the commercially available photopolymerization initiator include 2-benzyl-2-dimethylamino-1-(4-morpholinophenyl)-1-butanone, 1-hydroxycyclohexyl phenyl ketone, bis(2,4,6-trimethylbenzoyl)-phenyl phosphinoxide, 4-phenylbenzophenone, 4-phenoxybenzophenone, 4,4′-diphenylbenzophenone, and 4,4′-diphenoxybenzophenone.

The content of the photopolymerization initiator in the resin composition 2a is preferred to fall within a range of 0.01% by mass or more and 10% by mass or less. When the content of the photopolymerization initiator is 0.01% by mass or more, high reactivity can be obtained, and when the content is 10% by mass or less, a drop in light transmittance of the resin portion 2 which is a cured product can be reduced. An unreacted portion of the polymerization initiator remains in the resin portion 2 which is a cured product.

In addition, the resin composition 2a may contain, for example, a polymerization inhibitor, an antioxidant, a light stabilizer (HALS), a UV absorber, a silane coupling agent, a release agent, a pigment, and a dye, as required.

The resin portion 2 is preferred to be high in transparency. Specifically, the resin portion 2 is preferred to have an internal transmittance of 70% or more when converted to a thickness of 500 μm, with respect to light having a wavelength of 400 nm. The resin portion 2 is also preferred to have an Abbe number of 50 or more and 60 or less. When the transparency and the Abbe number of the resin portion 2 fall within those value ranges, the optical element 10 is applicable as a lens to optical systems of various optical designs.

The light-shielding film 3 of the optical element 10 according to this embodiment is described.

For light-shielding paint for forming the light-shielding film 3, a compound containing an epoxy group, inorganic fine particles, a coloring agent, an amine-based curing agent, and the like are usable. However, the light-shielding paint is not limited thereto, and materials that absorb visible light having a wavelength of from 400 nm to 700 nm may be used. As a coloring agent made of such a material, carbon black pigment, titanium black pigment, iron oxide pigment, or copper-iron-manganese composite oxide pigment, for example, is used. In a case of using a dye as the coloring agent, one kind of dye may be used alone or a mixture of a plurality of dyes that are some combination of, for example, black color, red color, yellow color, and blue color may be used.

For the light-shielding paint, an epoxy resin and a resin to which an amine-based cured product is cross-linked may also be used. As the kind of the epoxy resin, there may be used, for example, a bisphenol A-type epoxy resin, a bisphenol F-type epoxy resin, a polyfunctional epoxy resin, a flexible epoxy resin, a brominated epoxy resin, a glycidyl ester-type epoxy resin, a polymer-type epoxy resin, and a biphenyl-type epoxy resin. One kind of epoxy resin may be used alone, or a mixture of a plurality of kinds of epoxy resins may be used. In a case of using an epoxy resin for the light-shielding paint, the light-shielding paint may further contain an amine-based curing agent in order to cure a compound containing an epoxy group. The amine-based curing agent is not particularly limited as long as desired characteristics are satisfied, and publicly-known amine-based curing agents are usable. Specifically, as the amine-based curing agent, there may be used, for example, linear aliphatic-based, polyamide-based, alicyclic, and aromatic curing agent, and any other dicyandiamide, and adipic acid dihydrazide. Those amine-based curing agents may be used alone or in combination thereof.

As the inorganic fine particles, there may be used silica fine particles, and fine particles, such as titanium oxide, zirconium oxide, aluminum oxide, yttrium oxide, cadmium oxide, diamond, strontium titanate, and germanium.

In the present disclosure, a linear expansion coefficient of the light-shielding film 3 is between the linear expansion coefficient of the glass base material 1 and the linear expansion coefficient of the resin portion 2. The linear expansion coefficient of the light-shielding film 3 can be adjusted mainly by a proportion of mixing the resin and the inorganic file particles that are contained in the light-shielding film 3.

Next, description is given on a method of manufacturing the optical element 10 according to this embodiment, with reference to FIG. 4A and FIG. 4B. FIG. 4A and FIG. 4B are sectional views for illustrating arrangement of members in a step of forming the resin portion 2 of the optical element 10 which is illustrated in FIG. 1A to FIG. 1C on the first surface 1A of the glass base material 1. The arrangement of the members in FIG. 4A and FIG. 4B is illustrated in cross sections taken along a direction in which the glass base material 1 and the resin portion 2 are layered.

First, in a preparation step, the glass base material 1 on which the light-shielding film 3 has been formed and the resin composition 2a for forming the resin portion 2 are prepared.

At this point, it is preferred to perform pre-treatment on the first surface 1A of the glass base material 1 and a surface of the light-shielding film 3 in order to improve adhesion at which the resin portion 2 which is a cured product of the resin composition 2a is in close contact with the glass base material 1 and the light-shielding film 3.

When the glass base material 1 is made of glass, for example, a silane coupling treatment, a corona discharge treatment, a UV ozone treatment, or a plasma treatment may be selected as the pre-treatment.

As the pre-treatment, coupling treatment using a silane coupling agent is preferred in view of its capability of enhancing the adhesion even more by direct chemical bonding of the resin portion 2 to the first surface 1A and other surfaces on which the resin portion 2 is formed. That is, an application step for applying the coupling agent to at least a part of the first surface 1A that is not covered with the light-shielding film 3 and to a part of the surface of the light-shielding film 3 is preferred to be added prior to a following filling step.

Specific examples of the silane coupling agent include 3-methacryloxypropylmethyldimethoxysilane, 3-methacryloxypropyltrimethoxysilane, 8-methacryloxyoctyltrimethoxysilane, 3-acryloxypropyltrimethoxysilane, 3-methacryloxypropylmethyldiethoxysilane, and 3-methacryloxypropyltriethoxysilane.

Subsequently, in the filling step, a space between the glass base material 1 and a mold 4 is filled with the resin composition 2a. Specifically, first, the resin composition 2a is dropped on a surface of the mold 4 as illustrated in FIG. 4A. As described above, the resin composition 2a is, for example, a composition of a UV curable resin containing a photopolymerization initiator. The glass base material 1 is placed on an ejector 5 and positioned so as to be opposed to the mold 4. The mold 4 is, for example, a metallic mold that has, on a surface, an inverted shape of a desired aspherical shape, and that can be fabricated by plating a metal matrix such as a stainless-steel material or a steel material with NiP or oxygen-free copper, and cutting the plated matrix with a precision machining machine. A mold release agent may be applied to the surface of the mold 4 in order to control mold releasability of the resin portion 2. The mold release agent is not limited to a particular type, and, for example, a fluorine coating agent is usable as the mold release agent.

Subsequently, as illustrated in FIG. 4B, the resin composition 2a is provided on the glass base material 1 by lowering the ejector 5 and thus bringing mold 4 close to the glass base material 1. The space between the mold 4 and the glass base material 1 is filled with the resin composition 2a that is uncured by further lowering the ejector 5, and the resin composition 2a is molded into a desired shape.

In the method of manufacturing the optical element according to this embodiment, the filling step includes filling of the resin composition 2a so as to fill a space between the light-shielding film 3 and the mold 4 with a part of the resin composition 2a. This accomplishes interposition of the light-shielding film 3 between the resin portion 2 and the glass base material 1 when the resin composition 2a is cured.

Subsequently, in a curing step, the resin composition 2a is cured to form the resin portion 2. An example of curing the resin composition 2a by irradiating the resin composition 2a with an ultraviolet ray is described here.

As illustrated in FIG. 4B, an ultraviolet light source 6 is used to perform light irradiation in which an ultraviolet ray is radiated toward a part of the resin composition 2a that is located between the glass base material 1 and the mold 4 from the second surface 1B side of the glass base material 1. The resin composition 2a is thus polymerized and cured. The resin portion 2 which is a polymerized, cured product of the resin composition 2a is obtained as a result.

In this step, the part of the resin composition 2a that fills the space between the light-shielding film 3 and the mold 4 is shielded from the ultraviolet ray by the light-shielding film 3, and is consequently in an uncured state. One way to form the resin portion 2 between the light-shielding film 3 and the mold 4 is to finish an inner surface of the ejector 5 as a mirror surface. This enables the ultraviolet ray radiated from the ultraviolet light source 6 to reach the space between the light-shielding film 3 and the mold 4 by being reflected on the inner surface of the ejector 5. The part of the resin composition 2a that is located between the light-shielding film 3 and the mold 4 can thus be cured instead of being left uncured.

Another way to cure the part of the resin composition 2a that is located between the light-shielding film 3 and the mold 4 is to use a glass material through which the ultraviolet ray is transmissible so that the ultraviolet ray is radiated not only from the second surface 1B side of the glass base material 1 but also from a side on which the mold 4 is placed. The part of the resin composition 2a that is located between the light-shielding film 3 and the mold 4 can thus be cured.

The curing step is preferred to include radiation of the ultraviolet ray that sets a curing reaction rate of a part of the resin portion 2 that is formed by curing the resin composition 2a between the light-shielding film 3 and the mold 4, to 40% or more and 95% or less. This can facilitate releasing of the resin portion 2 as a cured product from the mold in a mold release step described later.

Then, in the mold release step, the resin portion 2 that has been polymerized and cured is released from the mold 4, to thereby obtain the optical element 10 including the resin portion 2 that is formed on the glass base material 1 and that has an aspherical shape.

After the resin portion 2 is formed, additional radiation of an ultraviolet ray in the atmospheric air or in an oxygen-free atmosphere, and thermal treatment may be executed. In particular, in a case in which the part of the resin composition 2a that is located between the light-shielding film 3 and the mold 4 partially remains uncured after being released from the mold, the part of the resin composition 2a that has been located between the light-shielding film 3 and the mold 4 is required to be cured by additional radiation of an ultraviolet ray from the resin portion 2 side.

Through the manufacturing method described above, the optical element 10 according to this embodiment can be manufactured. In the filling step, the resin composition 2a may be dropped on both of the mold 4 and the glass base material 1, or may be dropped only on the glass base material 1. In a case in which the resin composition 2a contains a thermal polymerization initiator as a curing initiator, the curing step may include a thermal treatment step.

### Second Embodiment

The optical element 10 according to the first embodiment described above is applicable to various types of equipment and apparatus such as optical equipment and image pickup apparatus. In this embodiment, optical equipment and image pickup apparatus are described as specific application examples of the optical element 10 according to the first embodiment.

### (Optical Equipment)

Specific application examples of the optical element 10 according to the first embodiment include a lens to be included in optical equipment (a photographing optical system) for a still camera or a video camera, and a lens to be included in optical equipment (a projection optical system) for a liquid crystal projector. The optical element 10 according to the first embodiment is also usable as a pickup lens of a DVD recorder or the like. Those pieces of optical equipment each include a housing and an optical system which is placed inside the housing and which includes at least one lens. Optical equipment according to this embodiment is characterized in that at least one of those lenses is the optical element 10 according to the first embodiment.

### (Image Pickup Apparatus)

An image pickup apparatus according to this embodiment is an image pickup apparatus including: a housing; an optical system which is placed inside the housing and which includes at least one lens; and an image pickup element which receives light that has traveled through the optical system. The image pickup apparatus according to this embodiment is characterized in that at least one of the at least one lens is the optical element 10 according to the first embodiment.

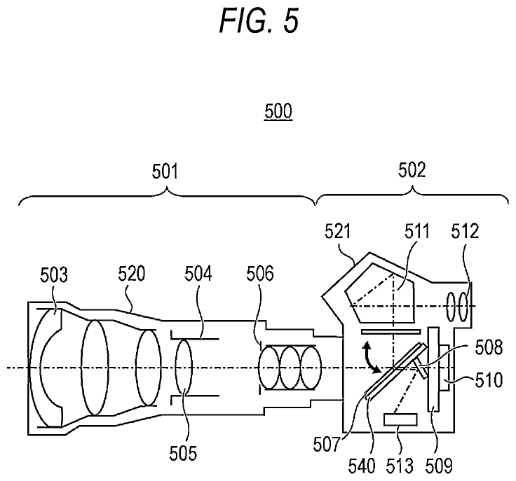

FIG. 5 is a schematic view for illustrating a configuration of a single-lens reflex digital camera 500, which is an example of an exemplary embodiment of the image pickup apparatus using the optical element 10 according to the first embodiment. In FIG. 5, a camera main body 502 and a lens barrel 501 which is optical equipment are joined to each other, but the lens barrel 501 is a replacement lens, so to speak, which is detachable from the camera main body 502.

Light from an object is photographed via the optical system including a plurality of lenses 503, 505, and others arranged on an optical axis of a photographing optical system inside a housing 520 of the lens barrel 501. The optical element 10 according to the first embodiment is usable for the lenses 503 and 505, for example. The lens 505 is supported by an inner barrel 504 in a manner that enables the lens 505 to move relative to an outer barrel of the lens barrel 501, for focusing and zooming.

In an observation period prior to photographing, the light from the object is reflected by a main mirror 507 inside the housing 521 of the camera main body, transmitted through a prism 511, and then viewed through a finder lens 512 by a photographer as a photographed image. The main mirror 507 is, for example, a half mirror, and light transmitted through the main mirror is reflected by a sub-mirror 508 to a direction of an auto-focus (AF) unit 513. This reflected light is used for ranging, for example. The main mirror 507 is attached to and supported by a main mirror holder 540 by adhesive bonding or other methods. In photographing, the main mirror 507 and the sub-mirror 508 are moved by a driving mechanism (not shown) to outside of an optical path, and a shutter 509 is opened so that an image pickup element 510 receives the light that has entered from the lens barrel 501 and that has been transmitted through the photographing optical system, and forms a photographing light image. A stop 506 is configured so that brightness and a focal depth in photographing can be changed by changing an opening area.

Although the image pickup apparatus has been described here using a single-lens reflex digital camera, the optical element 10 is similarly usable for a smartphone, a compact digital camera, a drone, and the like.

### EXAMPLES

The present disclosure is described in more detail below by way of Examples. First, a method of evaluating the optical element is described. Evaluation of the optical element was performed on appearance of the optical element and lens cracking.

### (Appearance)

Optical elements obtained in Examples and Comparative Examples were visually observed from the second surface side which was a side opposite from the resin portion, and how a bright line looked was evaluated. In the evaluation, the look of the bright line was ranked from Level A to Level C. At Level A, the bright line is completely invisible. At Level B, the bright line is slightly visible but is not a problem. At Level C, the bright line is clearly visible.

### (Lens Cracking)

Optical elements obtained in Examples and Comparative Examples in a room temperature state were put in a freezer controlled so as to maintain a temperature environment of −40° C., taken out after 24 hours to be returned to room temperature at 25° C., and then evaluated for appearance. Stress simulation in the rapid cooling at −40° C. was also performed by a finite element method to calculate an end portion of the resin portion that was estimated to be a start point of cracking.

The optical elements were ranked in terms of lens cracking from A to C. In the optical elements ranked A, the resin portion was not cracked, and a stress value of the end portion of the resin portion was less than 10 MPa. In the optical elements ranked B, the resin portion was not cracked, and a stress value of the end portion of the resin portion was equal to or more than 10 MPa. In the optical elements ranked C, the resin portion was cracked.

The optical elements according to Examples and Comparative Examples are described next.

### Example 1

The optical element 10 illustrated in FIG. 1A to FIG. 1C was fabricated by using the manufacturing method illustrated in FIG. 4A and FIG. 4B.

As the glass base material 1, a piece of optical glass (S-TIM8, manufactured by Ohara Corporation), which was 44 mm in diameter, and in which the flat surface 1D had a width of 5 mm, and the ridge line 1E was located between the flat surface 1D and the optical surface 1C, was prepared. The glass base material 1 includes the light-shielding film 3 (GT7-II: manufactured by Canon Chemicals, Inc.). The light-shielding film 3 is formed to have an inner diameter of 33 mm, and is applied so as to reach the optical surface 1C by crossing the ridge line 1E. The glass base material 1 is shaped so as to have, on one surface (the optical surface 1C), a concave spherical shape having a diameter of 34 mm, and a convex spherical shape having a diameter of 44 mm on another surface (the second surface 1B).

As the mold 4, an NiP layer plated on a metal matrix was subjected to cutting machining with a precision machining machine to form a shape that was an inversion of the aspherical shape of the resin portion 2, which was to be molded.

The inner surface of the ejector 5 was subjected to mirror finish machining for the purpose of reflecting an ultraviolet ray.

Next, a silane coupling agent containing a methacrylate group as a functional group was applied to surfaces of the glass base material 1 and the light-shielding film 3 for the purpose of improving adhesion between the glass base material 1 and the light-shielding film 3.

Next, the space between the mold 4 and the glass base material 1 was filled with the resin composition 2a. As the resin composition 2a, a composition containing an acrylic monomer that has a cyclic hydrocarbon in a main chain and a reactive acrylate group at a terminal, and a polymerization initiator (Omnirad 184 (1-hydroxycyclohexyl-phenyl ketone), manufactured by IGM Resins) was used.

Then, an ultraviolet ray having an intensity of 10 mW/cm² at a wavelength of 365 nm was radiated on an entire surface for 200 seconds to cure the resin composition 2a, and the cured product of the resin composition 2a was released from the mold 4 to form the resin portion 2 on the glass base material 1. An intermediate obtained by mold release was put in an oven and heated at 80° C. for 24 hours to manufacture an optical element according to Example 1.

A width of a lamination region R in which the light-shielding film 3 and the resin portion 2 were layered was measured in the obtained optical element 10. An outer diameter (a distance from the center P0 to the distal end of the resin portion 2 in a direction perpendicular to the optical axis direction O) of the resin portion 2 was 35 mm, and the light-shielding film 3 was interposed in a region by 1 mm from the outermost circumference of the resin portion 2. A ratio at which the width of the lamination region R took up the radius of the optical surface 1C was 1 mm/17 mm×100%-6%. Linear expansion coefficients of the glass base material 1, the light-shielding film 3, and the resin portion 2 were measured with use of a thermal mechanical analysis apparatus TMA (manufactured by METTLER TOLEDO), in a range of from −30° C. to −70° C., and were found to be 8 ppm/K, 60 ppm/K, and 100 ppm/K, respectively.

The absorption expansion rate of the resin portion 2 was measured as follows.

First, the resin portion 2 was cut out of the surface of the optical element 10 separately prepared in order to measure the absorption expansion rate. Specifically, a feather razor was used to make a cut into the resin portion 2 on the surface of the optical element 10, and a film was peeled away by inserting the razor to an adhesive bonding surface between the resin portion 2 and the glass base material 1. A distribution of a film thickness in one sample was adjusted so that a range of fluctuations of the thickness fell within 10%. The film was given a slip shape of 10 mm×1 mm.

The absorption expansion rate of the peeled film was measured by a tensile load method, with temperature and humidity controlled to be 60° C. and 90% RH, by using an apparatus (TMA-4000SE+HC9700 (humidity control type), manufactured by NETZSCH Japan K. K.) for measuring a linear expansion coefficient of a material.

The curing reaction rate of the part of the resin portion 2 that had been formed between the light-shielding film 3 and the mold 4 was measured with use of a Fourier transform infrared spectroscopy (FTIR) apparatus (product name: Spectrum One, manufactured by PerkinElmer). Specifically, a peak area related to a double bond of carbon in a light absorption spectrum of the resin portion 2 that had been obtained by FTIR was obtained, and the curing reaction rate was calculated by the following expression.

$$( 1 - \frac{S 1 / S 2}{S 3 / S 4} ) \times 100$$

S1: a peak area related to the double bond in a cured state
S2: a peak area unrelated to the double bond in a cured state
S3: a peak area related to the double bond in an uncured state
S4: a peak area unrelated to the double bond in an uncured state

### Example 2

The optical element 10 according to Example 2 was fabricated in the same manner as in Example 1, except that an acrylic monomer having a straight chain hydrocarbon in a main chain was used as a material of the resin composition 2a. A linear expansion coefficient of a resin portion included in the optical element 10 according to Example 2 was 170 ppm/K.

### Example 3

The optical element 10 according to Example 3 was fabricated in the same manner as in Example 1, except that the resin portion 2 was formed so as to have an outer diameter of 33.8 mm. In the optical element 10 according to Example 3, the resin portion 2 was formed only on the optical surface 1C, unlike FIG. 3 in which the ridge line 1E was crossed. The width of the lamination region R was 0.4 mm, and a ratio at which the width of the lamination region R took up the radius of the optical surface 1C was 0.4 mm/17 mm×100%=2%.

### Example 4

The optical element 10 according to Example 4 was fabricated in the same manner as in Example 1, except that the resin portion 2 was formed so as to have an outer diameter of 33.2 mm. In the optical element 10 according to Example 4, the resin portion 2 was formed only on the optical surface 1C, unlike FIG. 3 in which the ridge line 1E was crossed. The width of the lamination region R was 0.1 mm, and a ratio at which the width of the lamination region R took up the radius of the optical surface 1C was 0.1 mm/17 mm×100%=0.5%.

### Example 5

The optical element 10 according to Example 5 was fabricated in the same manner as in Example 1, except that a silane coupling agent having a vinyl group was used as a silane coupling agent. In the optical element 10 according to Example 5, the resin portion 2 was observed not to sit flatly on the flat surface 1D.

### Example 6

The resin composition 2a used in Example 1 and the resin composition 2a that contains an acrylic monomer having urethane in a main chain and that contains the polymerization initiator described above were mixed at a proportion by weight of 80:20. The mixture was used as the resin composition 2a. Except for the foregoing, the optical element 10 according to Example 6 was fabricated in the same manner as in Example 1.

### Example 7

The optical element 10 according to Example 7 was fabricated in the same manner as in Example 1, except that reflection by the inner surface of the ejector was not used in an ultraviolet ray radiation step. In the optical element 10 according to Example 7, the outer diameter of the resin potion 2 was 33.4 mm.

### Example 8

The optical element 10 according to Example 8 was fabricated in the same manner as in Example 1, except that, by using a quartz glass mold, irradiation with an ultraviolet ray from above and irradiation with an ultraviolet ray from below were executed at the same time in the ultraviolet ray radiation step. In the optical element 10 according to Example 8, the outer diameter of the resin potion 2 was 35.7 mm.

### Example 9

The optical element 10 according to Example 9 was fabricated in the same manner as in Example 1, except that ultraviolet ray radiation was additionally executed from the resin portion 2 side after the mold release. In the optical element 10 according to Example 9, the outer diameter of the resin potion 2 was 35.7 mm.

### Examples 10, 18, and 20 to 22

The optical element 10 according to each of Examples 10, 18, and 20 to 22 was fabricated in the same manner as in Example 1, except that the mold 4 different from the mold 4 used in Example 1 in terms of the shape adapted to the aspherical shape of the resin portion 2 was used.

### Example 11

Paint was obtained by adding QSG-100 (manufactured by Shin-Etsu Chemical Col, Ltd.) to GT7-II (manufactured by CANON Chemicals, Inc.) at a proportion of 20 parts by weight to 100 parts by weight, and stirring the mixture until the mixture was homogeneous. The paint was used to form the light-shielding film 3 on the glass base material 1. The resin composition 2a used here was obtained by mixing the resin composition 2a used in Example 1 with the resin composition 2a that contains an acrylic monomer having a cyclic hydrocarbon in a main chain and having an acrylate group in a side chain and at a terminal, and that contains the polymerization initiator described above, at a proportion by weight of 50:50. Except for the foregoing, the optical element 10 according to Example 11 was fabricated in the same manner as in Example 1.

### Example 12

The resin composition 2a used in Example 1 and the resin composition 2a used in Example 2 were mixed at a proportion by weight of 30:70, and the mixture was used as the resin composition 2a. Except for the foregoing, the optical element 10 according to Example 12 was fabricated in the same manner as in Example 1.

### Example 13

The optical element 10 according to Example 13 was fabricated in the same manner as in Example 1, except that, by using a quartz glass mold, irradiation with an ultraviolet ray from above and irradiation with an ultraviolet ray from below were executed at the same time in the ultraviolet ray radiation step. In the optical element 10 according to Example 13, the outer diameter of the resin potion 2 was 36.4 mm.

### Example 14

The resin composition 2a used in Example 1 and the resin composition 2a that contains an acrylic monomer having a cyclic hydrocarbon in a main chain and having an acrylate group in a side chain and at a terminal, and that contains the polymerization initiator described above, were mixed at a proportion by weight of 80:20. The mixture was used as the resin composition 2a. Except for the foregoing, the optical element 10 according to Example 14 was fabricated in the same manner as in Example 1.

### Example 15

The resin composition 2a used in Example 1 and the resin composition 2a used in Example 2 were mixed at a proportion by weight of 40:60, and the mixture was used as the resin composition 2a. Except for the foregoing, the optical element 10 according to Example 15 was fabricated in the same manner as in Example 1.

### Examples 16, 17, and 19

The optical element 10 according to each of Examples 16, 17, and 19 was fabricated in the same manner as in Example 4, except that the mold 4 different from the mold 4 used in Example 4 in terms of the shape adapted to the aspherical shape of the resin portion 2 was used.

### Example 23

The resin composition 2a used in Example 1 and the resin composition 2a that contains an acrylic monomer having urethane in a main chain and that contains the polymerization initiator described above were mixed at a proportion by weight of 70:30. The mixture was used as the resin composition 2a. Except for the foregoing, the optical element 10 according to Example 23 was fabricated in the same manner as in Example 1.

### Comparative Example 1

A space between a glass base material having no light-shielding film and a mold was filled with a resin composition, and, after the resin composition was cured, a light-shielding film was formed on a part of a side surface and a flat surface of the glass base material and on an end portion of a resin portion. Except for the foregoing, an optical element according to Comparative Example 1 was fabricated in the same manner as in Example 1.

The curing reaction rate was measured for the end portion of the resin portion on which the light-shielding film was layered.

### Comparative Example 2

An optical element according to Comparative Example 2 was fabricated in the same manner as in Example 1, except that an inner diameter of the light-shielding film was set to 37 mm, and that the lamination region R was not included.

The curing reaction rate was measured for the end portion of the resin portion.

### Comparative Example 3

To the paint for forming a light-shielding film, 50 parts by weight of titanium oxide (MT-05, a product of TAYCA Co., Ltd.) were added, and the resultant paint was used to form a light-shielding film on the glass base material. Except for the foregoing, an optical element according to Comparative Example 3 was fabricated in the same manner as in Example 1. The linear expansion coefficient of the light-shielding film included in the optical element according to Comparative Example 3 was 110 ppm/K.

Physical properties of the optical elements according to Examples and Comparative Examples are shown in Table 1-1 below and evaluation results are shown in Table 1-2 below.

In Table 1-1 and Table 1-2, P0 and P1 indicate positions corresponding to the center P0 of the optical surface 1C illustrated in FIG. 1A to FIG. 1C and the point P1 at which the resin portion 2 has the maximum thickness, respectively. The point P1 is a point apart by 13 mm from the center P0 in a radial direction of the optical surface 1C. A lamination region width ratio in Table 1 indicates a ratio of the width of the region in which the resin portion and the light-shielding film are layered to the radius of the optical surface.

It is understood from Table 1-1 and Table 1-2 that the optical element 10 according to any one of Examples 1 to 23 is superior to the optical elements of Comparative Examples 1 to 3.

TABLE 1-1

| | Resin | | | Linear expansion | | | | | |
|---|---|---|---|---|---|---|---|---|---|
| | portion | | | coefficient [ppm/K] | | | Moisture | Lamination | |
| | thickness | | | Glass | Light- | | absorption | region | Curing |
| | [mm] | | | base | shielding | Resin | expansion | width ratio | reaction |
| | P0 | P1 | P1/P0 | material | film | portion | rate [%] | [%] | rate [%] |
| Example 1 | 0.05 | 0.25 | 5.0 | 8 | 60 | 100 | 0.2 | 6 | 60 |
| Example 2 | 0.05 | 0.25 | 5.0 | 8 | 60 | 170 | 0.2 | 6 | 60 |
| Example 3 | 0.05 | 0.25 | 5.0 | 8 | 60 | 100 | 0.2 | 2 | 60 |
| Example 4 | 0.05 | 0.25 | 5.0 | 8 | 60 | 100 | 0.2 | 0.5 | 60 |
| Example 5 | 0.05 | 0.25 | 5.0 | 8 | 60 | 100 | 0.2 | 6 | 60 |
| Example 6 | 0.05 | 0.25 | 5.0 | 8 | 60 | 100 | 0.8 | 6 | 60 |
| Example 7 | 0.05 | 0.25 | 5.0 | 8 | 60 | 100 | 0.2 | 1 | 40 |
| Example 8 | 0.05 | 0.25 | 5.0 | 8 | 60 | 100 | 0.2 | 8 | 80 |
| Example 9 | 0.05 | 0.25 | 5.0 | 8 | 60 | 100 | 0.2 | 8 | 80 |
| Example 10 | 0.05 | 0.08 | 1.5 | 8 | 60 | 100 | 0.2 | 6 | 60 |
| Example 11 | 0.05 | 0.25 | 5.0 | 8 | 45 | 50 | 0.2 | 6 | 60 |
| Example 12 | 0.05 | 0.25 | 5.0 | 8 | 60 | 150 | 0.2 | 6 | 60 |
| Example 13 | 0.05 | 0.25 | 5.0 | 8 | 60 | 100 | 0.2 | 10 | 60 |
| Example 14 | 0.05 | 0.25 | 5.0 | 8 | 60 | 80 | 0.2 | 6 | 60 |
| Example 15 | 0.05 | 0.25 | 5.0 | 8 | 60 | 140 | 0.2 | 6 | 60 |
| Example 16 | 0.05 | 0.08 | 1.5 | 8 | 60 | 100 | 0.2 | 0.5 | 60 |
| Example 17 | 0.05 | 0.20 | 4.0 | 8 | 60 | 100 | 0.2 | 0.5 | 60 |
| Example 18 | 0.05 | 0.50 | 10.0 | 8 | 60 | 100 | 0.2 | 6 | 60 |
| Example 19 | 0.20 | 0.05 | 0.3 | 8 | 60 | 100 | 0.2 | 0.5 | 60 |
| Example 20 | 0.20 | 0.04 | 0.2 | 8 | 60 | 100 | 0.2 | 6 | 60 |
| Example 21 | 0.20 | 0.13 | 0.7 | 8 | 60 | 100 | 0.2 | 6 | 60 |
| Example 22 | 0.20 | 0.02 | 0.1 | 8 | 60 | 100 | 0.2 | 6 | 60 |
| Example 23 | 0.05 | 0.25 | 5.0 | 8 | 60 | 100 | 1.1 | 6 | 60 |
| Comparative | 0.05 | 0.25 | 5.0 | 8 | 60 | 100 | 0.2 | 6 | 80 |
| Example 1 | | | | | | | | | |
| Comparative | 0.05 | 0.25 | 5.0 | 8 | 60 | 100 | 0.2 | 0 | 10 |
| Example 2 | | | | | | | | | |
| Comparative | 0.05 | 0.25 | 5.0 | 8 | 110 | 100 | 0.2 | 6 | 60 |
| Example 3 | | | | | | | | | |

TABLE 1-2

| | Evaluation | | |
|---|---|---|---|
| | Stress value | | Lens |
| | [MPa] | Appearance | cracking |
| Example 1 | 5 | A | A |
| Example 2 | 18 | A | B |
| Example 3 | 15 | B | B |
| Example 4 | 19 | B | B |
| Example 5 | 5 | A | A |
| Example 6 | 14 | A | B |
| Example 7 | 18 | B | B |
| Example 8 | 4 | A | A |
| Example 9 | 4 | A | A |
| Example 10 | 1 | A | A |
| Example 11 | 18 | A | B |
| Example 12 | 14 | A | A |
| Example 13 | 3 | A | A |
| Example 14 | 6 | A | A |
| Example 15 | 6 | A | A |
| Example 16 | 2 | B | A |
| Example 17 | 7 | B | A |
| Example 18 | 8 | A | A |
| Example 19 | 1 | B | A |
| Example 20 | 5 | A | A |
| Example 21 | 1 | A | A |
| Example 22 | 8 | A | A |
| Example 23 | 14 | A | B |
| Comparative | 30 | A | C |
| Example 1 | | | |
| Comparative | 39 | C | C |
| Example 2 | | | |
| Comparative | 25 | A | C |
| Example 3 | | | |

According to the present disclosure, the optical element that has excellent quality of appearance and excellent environmental durability both at the same time, and the method of manufacturing the optical element can be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-005012, filed Jan. 17, 2024, which is hereby incorporated by reference herein in its entirety.

What is claimed is:

1. An optical element comprising:
a glass base material including a first surface and a second surface opposed to the first surface;
a resin portion provided on the first surface; and
a light-shielding film configured to cover at least a part of a side surface of the glass base material and a part of the first surface,
wherein the second surface is one of an incident surface or an exit surface for light,
wherein a part of the light-shielding film is provided between the glass base material and the resin portion, and
wherein a linear expansion coefficient of the light-shielding film is between a linear expansion coefficient of the glass base material and a linear expansion coefficient of the resin portion.

2. The optical element according to claim 1, wherein a surface of the resin portion on a side opposite from a surface thereof that is in contact with the glass base material is exposed to atmospheric air.

3. The optical element according to claim 1, wherein at least one of the following is satisfied:
a ratio of a maximum thickness of the resin portion in an optical axis direction to a thickness of the resin portion in the optical axis direction at a center position of an optical surface of the first surface is 5 or more; and
a ratio of a minimum thickness of the resin portion in the optical axis direction to the thickness of the resin portion in the optical axis direction at the center position of the optical surface of the first surface is ⅕ or less.

4. The optical element according to claim 1, wherein the linear expansion coefficient of the resin portion is 50 ppm/K or more and 150 ppm/K or less.

5. The optical element according to claim 1,
wherein the first surface includes an optical surface, a flat surface provided along an outer edge of the optical surface, and a ridge line which is a boundary line between the optical surface and the flat surface,
wherein the resin portion is provided so as to spread from the optical surface, cross the ridge line, and reach a part of the flat surface, and
wherein the light-shielding film is provided so as to spread from the flat surface, cross the ridge line, and reach a part of the optical surface.

6. The optical element according to claim 5, wherein, in a case that a radius of the optical surface is 100%, a width of a region in which the resin portion and the light-shielding film are layered is 1% or more and 10% or less in a direction perpendicular to an optical axis direction.

7. The optical element according to claim 1, wherein the resin portion has a moisture absorption expansion rate of 0.8% or less.

8. Optical equipment comprising:
a housing; and
an optical system including at least one lens placed inside the housing,
wherein at least one of the at least one lens is the optical element of claim 1.

9. An image pickup apparatus comprising:
a housing;
an optical system including at least one lens placed inside the housing; and
an image pickup element which receives light that has traveled through the optical system,
wherein at least one of the at least one lens is the optical element of claim 1.

10. A method of manufacturing an optical element, the optical element including a glass base material and a resin portion, the glass base material including a first surface and a second surface opposed to the first surface, the resin portion being provided on the first surface, the second surface being one of an incident surface or an exit surface for light,
the method comprising:
a preparation step of preparing the glass base material on which a light-shielding film has been formed;
a filling step of filling a space between the glass base material and a mold with a resin composition;
a curing step of curing the resin composition to form the resin portion; and
a mold release step of releasing the resin portion from the mold,
wherein the light-shielding film is formed on the glass base material so as to cover at least a part of a side surface of the glass base material and a part of the first surface, and
wherein the filling step includes filling with the resin composition so that a space between the light-shielding film and the mold is filled with part of the resin composition.

11. The method of manufacturing an optical element according to claim 10, wherein a surface of the resin portion on a side opposite from a surface thereof that is in contact with the glass base material is exposed to atmospheric air.

12. The method of manufacturing an optical element according to claim 10, wherein the curing step includes irradiating with an ultraviolet ray so that the resin portion formed by curing of the part of the resin composition between the light-shielding film and the mold has a curing reaction rate of 40% or more and 95% or less.

13. The method of manufacturing an optical element according to claim 10, further comprising, before the filling step, an application step of applying a coupling agent to at least a part of the first surface that is not covered with the light-shielding film and a part of a surface of the light-shielding film.
